(19) United States
(12) Patent Application Publication
(10) Pub. No.: US 2025/0190126 A1
(43) Pub. Date: Jun. 12, 2025

(54) MANAGING READ COMMANDS USING COMMAND WORKLOADS

(71) Applicant: Micron Technology, Inc., Boise, ID (US)

(72) Inventors: Yu-Chung Lien, San Jose, CA (US); Tingjun Xie, Milpitas, CA (US); Zhenming Zhou, San Jose, CA (US)

(21) Appl. No.: 18/965,491

(22) Filed: Dec. 2, 2024

Related U.S. Application Data
(60) Provisional application No. 63/607,720, filed on Dec. 8, 2023.

(51) Int. Cl. G06F 3/06

(52) U.S. Cl. CPC G06F 3/0625; G06F 3/0659; G06F 3/0679

(57) ABSTRACT

Methods, systems, and apparatuses include receiving, by a memory subsystem, a read command. A command workload for the memory subsystem is determined. A forward read trim setting is selected in response to determining the command workload of the memory subsystem satisfies a threshold. The read command is executed using the selected forward read trim setting.

### CROSS-REFERENCE TO RELATED APPLICATION

The present application claims the benefit of U.S. Provisional Patent Application No. 63/607,720 filed on Dec. 8, 2023, which is incorporated by reference herein in its entirety.

### TECHNICAL FIELD

The present disclosure generally relates to managing read commands in a memory subsystem, and more specifically, relates to managing read command trim settings using command workloads.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 illustrates another example computing system that includes a read command management component in accordance with some embodiments of the present disclosure.

FIG. 3 is a flow diagram of an example method to manage read command trim settings using command workloads in accordance with some embodiments of the present disclosure.

FIG. 4 is another flow diagram of an example method to manage read command trim settings using command workloads in accordance with some embodiments of the present disclosure.

FIG. 5 is another flow diagram of an example method to manage read command trim settings using command workloads in accordance with some embodiments of the present disclosure.

FIG. 6 is a block diagram of an example computer system in which embodiments of the present disclosure may operate.

### DETAILED DESCRIPTION

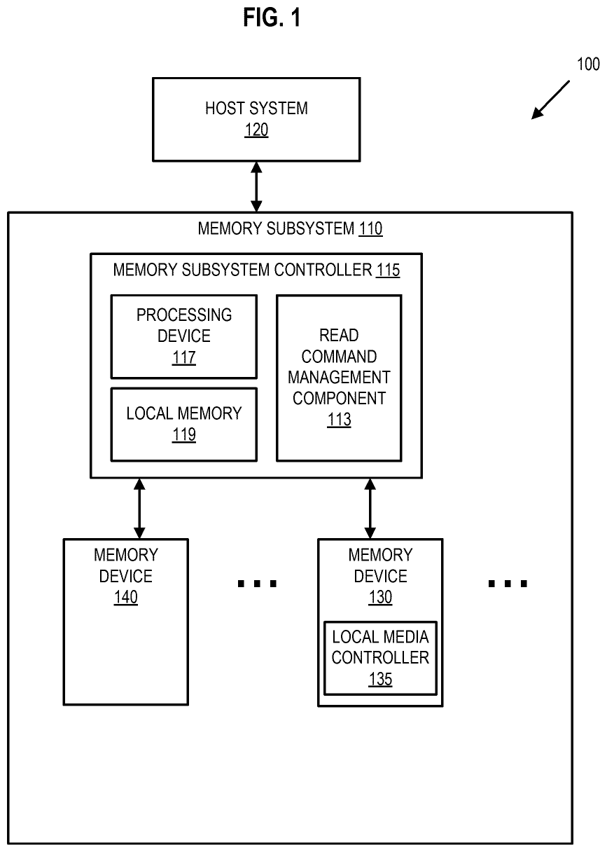

Aspects of the present disclosure are directed to determining read command trim settings using command workloads in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units identified by a logical unit number (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store four bits of information and has sixteen logic states.

Memory subsystems include internal media management processes that issue commands to read data from media or write data to media. In general, a read operation involves applying a voltage to a word line. The memory subsystem uses word lines and bit lines to access memory cells of the memory subsystem. By applying a charge to the word line, the transistor gate (e.g., a memory cell of the memory subsystem) opens, allowing any stored charge of the transistor to flow to a decoder via the bit line, mapping the charge to a bit value. For example, a memory cell can represent different bit values through the application of different threshold voltage values to the transistor gate.

As described herein, a trim setting can provide voltage information, including a sequence of voltage thresholds corresponding to one or more memory cells, used to program or access the memory cells. For example, an SLC can store one of two possible bit values (“0” and “1”) and each of two different threshold voltages can be applied to the gate of the transistor in a read operation. The threshold voltage results in source/drain conduction indicating the current state of the bit value. Similarly, MLC, TLC, QLC, and PLC memory represent more than two possible bit values and have a corresponding additional number of different threshold voltage values used in a read operation to determine the current bit values. Applying an increasing sequence of threshold voltages to the word line is considered a “forward read operation.” That is, the forward read operation is performed on lower threshold voltage states of a word line before higher threshold voltage states of the word line. Applying a decreasing sequence of threshold voltages to the word line is considered a “reverse read operation.” That is, the reverse read operation is performed on higher threshold voltage states of a word line before lower threshold voltage states of the word line. Both forward read operations and reverse read operations are associated with advantages and disadvantages. For example, reverse read operations are faster than forward read operations. However, forward read operations are more power efficient than reverse read operations.

Memory systems manage power consumption for optimal functionality. For example, memory systems that exceed their instantaneous power limitations will experience voltage droop. Voltage droop reduces the number of dice that can operate in parallel, reducing the efficiency of the memory system. Voltage droop can also cause failure and malfunction of the effected memory devices. Memory systems that exceed their average power limitations cause battery lifetime reductions for battery operated memory systems and negative impacts to parallelism for higher capacity memory systems. In order to benefit from the faster speeds of reverse read operations, conventional memory subsystems face the tradeoff of the inherent risks of voltage droop, battery lifetime reduction, and the negative impacts to parallelism.

Aspects of the present disclosure address the above and other deficiencies by dynamically determining read command trim settings based on command workloads. For example, the memory subsystem can determine whether to use a forward read operation trim setting or a reverse read operation trim setting based on commands in a command queue. The memory subsystem can determine the read operation trim settings based on estimated power consumption for the command queue and/or read traffic for the command queue. The memory subsystem can therefore benefit from the read time efficiencies of reverse read operations when not at risk of exceeding power consumption limitations and benefit from the power efficiencies of forward read operations when at risk of exceeding power consumption limitations. Additionally, the memory subsystem can reduce the risks of voltage droop, battery lifetime reduction, and negatively impacted parallelism.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processing device such as a processor chipset and a software stack executed by the processor chipset. The processor chipset can include one or more cores, one or more caches, a memory controller (e.g., NVDIMM controller), and/or a storage protocol controller (e.g., a peripheral component interconnect express (PCIe) controller, a serial advanced technology attachment (SATA) controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a SATA interface, including a mini-SATA (mSATA) interface, a PCIe interface, including a mini PCIe (mPCIE) interface, a Non-Volatile Memory Express (NVMe) interface, a universal serial bus (USB) interface, an a Fibre Channel, Serial Attached SCSI (SAS), a Small Computer System Interface (SCSI), a double data rate (DDR) memory bus, a dual in-line memory module (DIMM) interface (e.g., DIMM socket interface that supports Double Data Rate (DDR)), an Advanced Host Controller (AHCI) interface, an Open NAND Flash Interface (ONFI) interface, a Double Data Rate (DDR) interface, a Low Power Double Data Rate (LPDDR) interface, any other interface, and/or combinations of these interfaces. The physical host interface can be used to transmit data between the host system 120 and the memory subsystem 110. The host system 120 can further utilize an NVMe interface to access components (e.g., memory devices 130 and 140) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via the same communication connection, multiple separate communication connections, and/or a combination of communication connections.

The memory devices 130 and 140 can include any combination of the different types of non-volatile memory devices and/or volatile memory devices. The volatile memory devices (e.g., memory device 140) can be, but are not limited to, random-access memory (RAM), such as dynamic random-access memory (DRAM), synchronous dynamic random-access memory (SDRAM), video random-access memory (VRAM), and cache memory.

Some examples of non-volatile memory devices (e.g., memory device 130) include negative-and (NAND) type flash memory devices and write-in-place type memory devices, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), Spin Transfer Torque (STT)-MRAM, nano-RAM (NRAM), silicon-oxide-nitride-oxide-silicon (SONOS) memory, conductive bridging RAM (CBRAM), resistive random-access memory (RRAM), oxide based RRAM (OxRAM), negative-or (NOR) flash memory, and erasable programmable read-only memory (EPROM), including electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The buffer memory of subsystem controller 115 can include any of the volatile or non-volatile memory types mentioned above including combinations thereof. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in memory subsystem 110 (e.g., stored in a local memory 119). In some examples, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processing device or controller separate from the memory subsystem 110).

In general, the memory subsystem controller 115 can receive commands or operations from the host system 120 and can convert the commands or operations into instructions or appropriate commands to achieve the desired access to the memory devices (e.g., memory devices 130 and/or 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA) and/or namespace) and a physical address (e.g., physical block address) that are associated with the memory devices (e.g., memory devices 130 and/or 140). The memory subsystem controller 115 can further include host interface circuitry to communicate with the host system 120 via the physical host interface. The host interface circuitry can convert the commands received from the host system into command instructions to access the memory devices (e.g., memory devices 130 and/or 140) as well as convert responses associated with the memory devices into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices (e.g., memory devices 130 and/or 140).

In some embodiments, the memory devices (e.g., memory devices 130 and/or 140) include local media controllers 135 that operate in conjunction with memory subsystem controller 115 to execute operations on one or more memory cells of the memory devices (e.g., memory devices 130 and/or 140). An external controller (e.g., memory subsystem controller 115) can externally manage the memory devices (e.g., perform media management operations on the memory devices 130 and/or 140). In some embodiments, a memory device (e.g., memory device 130) is a managed memory device, which is a raw memory device combined with a local controller (e.g., local controller 135) for media management within the same memory device package. An example of a managed memory device is a managed NAND (MNAND) device.

The memory subsystem 110 includes a read command management component 113 that determines read trim settings using command workloads. In some embodiments, the controller 115 includes at least a portion of the read command management component 113. For example, the controller 115 can include a processing device 117 configured to execute instructions stored in local memory 119 for performing the operations described herein. In some embodiments, a read command management component 113 is part of the host system 120, an application, or an operating system.

The read command management component 113 determines read command trim settings using power budgets and/or read traffic of the memory subsystem. In some embodiments, read command management component 113 determines read trim settings using a power budget of memory subsystem 110. In some embodiments, read command management component 113 determines read trim settings using read traffic of memory subsystem 110. Further details with regard to the operations of the read command management component 113 are described below.

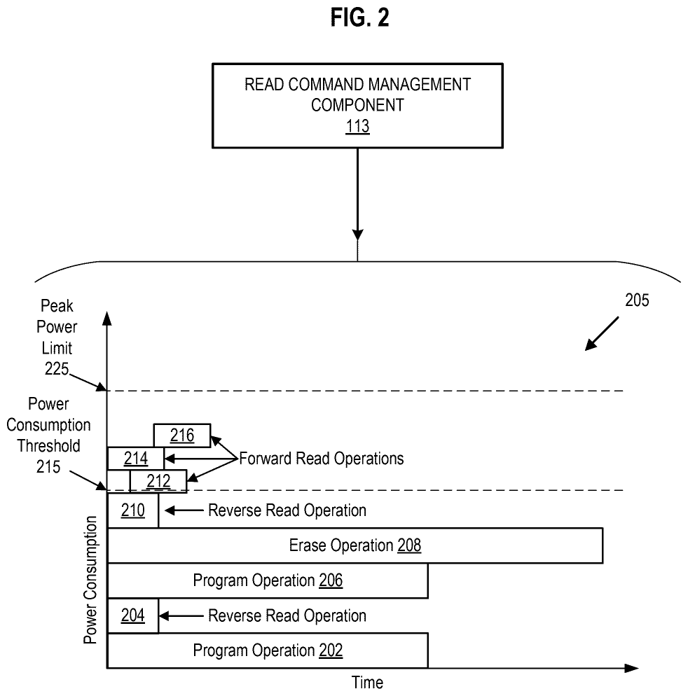

FIG. 2 illustrates an exemplary power consumption graph 205 that shows read command management component 113 managing read command trim settings. Power consumption graph 205 illustrates read command management component 113 managing multiple memory operations. Read command management component 113 tracks the different memory operations issued and executing in parallel. For example, as shown in FIG. 2, the memory operations include program operations 202 and 206, reverse read operations 204 and 210, erase operation 208, and forward read operations 212, 214, and 216. The memory operations are operations performed by a memory subsystem on memory device(s) (e.g., performed by memory subsystem 110 on memory devices 140) and time in which the operations are performed can overlap. In some embodiments, the memory operations are in response to a command from a host system. For example, host system 120 of FIG. 1, sends a memory command to memory subsystem 110 to perform a program operation and memory subsystem 110 initiates program operation 202 on memory device 140.

Exemplary power consumption graph 205 illustrates the power consumed for each of the memory operations 202, 204, 206, 208, 210, 212, 214, and 216 as well as time duration of the operation. The height (distance along the power consumption axis) of each of the memory operations 202, 204, 206, 208, 210, 212, 214, and 216 corresponds with an expected amount of power consumed for each of memory operations 202, 204, 206, 208, 210, 212, 214, and 216. For example, forward read operations 212, 214, and 216 are narrower (span less distance along the power consumption axis) than reverse read operations 204 and 210 because forward read operations 212, 214, and 216 have a smaller power requirement. Similarly, forward read operations 212, 214, and 216 are longer (span more distance along the time axis) than reverse read operations 204 and 210 because forward read operations 212, 214, and 216 take longer to execute. The length (distance along the time axis) of each of the memory operations 202, 204, 206, 208, 210, 212, 214, and 216 corresponds with the expected time duration of each of the memory operations 202, 204, 206, 208, 210, 212, 214, and 216. For example, erase operation 208 is significantly longer (spans a greater distance along the time axis) than any of the other memory operations because erase operation 208 takes the longest amount of time to complete. The overall area of each of the memory operations 202, 204, 206, 208, 210, 212, 214, and 216 therefore corresponds with the total expected power consumption for the memory operation.

Exemplary power consumption graph 205 includes power budget threshold 215 and peak power limit 225. Peak power limit 225 is the limit to the amount of power that the memory subsystem can instantaneously provide. For example, peak power limit 225 is an instantaneous power consumption value that maximizes the possible power consumption without the memory subsystem experiencing voltage droop that would cause system malfunction. In some embodiments, peak power limit 225 for a memory subsystem is predetermined and stored (e.g., in local memory 119 of FIG. 1).

Power budget threshold 215 is a power threshold determined as a percentage of or other offset from peak power limit 225. For example, power budget threshold 215 is 70% of peak power limit 225. In some embodiments, read command management component 113 determines power budget threshold 215 for memory subsystem 110 based on the memory devices of memory subsystem 110. For example, read command management component 113 determines that power budget threshold 215 is 60% of peak power limit 225 for a memory subsystem with a smaller drive capacity memory device but determines that power budget threshold 215 is 80% of peak power limit 225 for a memory subsystem with a larger drive capacity memory device. In some embodiments, power budget threshold 215 is a predetermined percent of peak power limit 225.

Read command management component 113 manages read command trim settings based on the power consumption of the memory subsystem. For example, memory subsystem 110 receives a read command from host system 120 when memory subsystem 110 is already executing program operation 202 (or otherwise manages the read command in parallel with program operation 202). Read command management component 113 determines that the expected power consumption for executing the read operation in parallel with program operation 202 will not exceed power budget threshold 215 and selects a reverse read trim setting to issue the read command as reverse read operation 204.

Memory subsystem 110 receives another read command from host system 120 when memory subsystem 110 is executing program operation 202, reverse read operation 204, program operation 206, and erase operation 208 (or otherwise manages the read command in parallel with operations 202, 204, and 206). Read command management component 113 determines that the expected power consumption for executing the additional read operation, in combination with operations 202, 204, and 206, will still not exceed power budget threshold 215 and selects a reverse read trim setting to issue the read command as reverse read operation 210.

Memory subsystem 110 receives or processes more read commands from host system 120 when memory subsystem 110 is executing program operation 202, reverse read operation 204, program operation 206, erase operation 208, and reverse read operation 210. Read command management component 113 determines that the expected power consumption for executing the additional read operations will exceed power budget threshold 215 and therefore selects a forward read trim setting to issue the additional read operations as forward read operations 212, 214, and 216.

In some embodiments, read command management component 113 uses a different workload metric for determining whether a command workload of the memory subsystem satisfies a threshold. For example, instead of measuring power consumption versus power budget threshold 215, read command management component 113 determines whether a number of read commands in a command queue to be issued in parallel satisfies a threshold number of read commands.

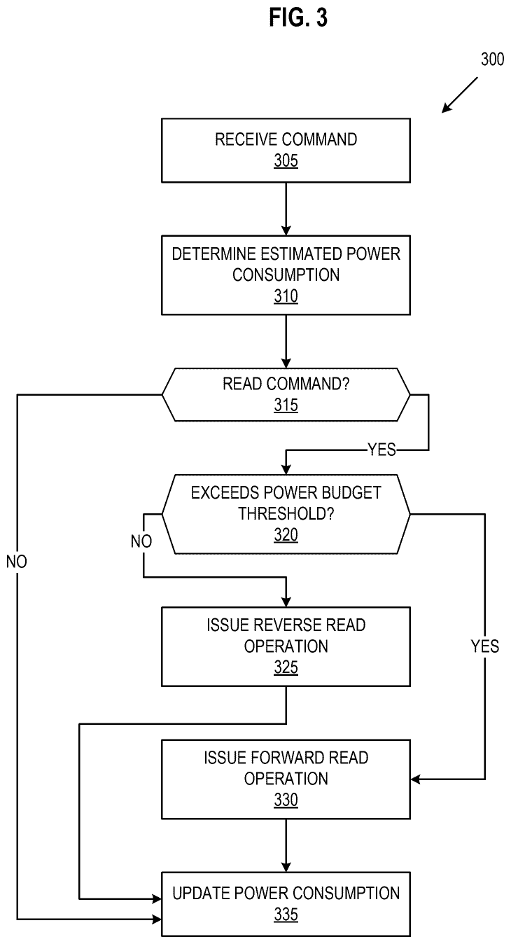

FIG. 3 is a flow diagram of an example method 300 to manage read command trim settings using command workloads, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the read command management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device receives a command. For example, memory subsystem 110 receives a command from host system 120 instructing memory subsystem 110 to perform a memory operation. In some embodiments, memory subsystem 110 receives one of a program command instructing memory subsystem 110 to write data to a memory device, a read command instructing memory subsystem 110 to read data from a memory device, and an erase command instructing memory subsystem 110 to erase data from a memory device.

At operation 310, the processing device determines an estimated power consumption for the received command. For example, read command management component 113 estimates the power consumption for the received command based on the command type. In some embodiments, read command management component 113 retrieves power consumption estimates from a local memory based on the command type (e.g., via a look-up table). In some embodiments, read command management component 113 estimates an instantaneous power consumption for the received command. In some embodiments, read command management component 113 estimates the power consumption based on the size of the memory command. For example, read command management component 113 estimates the power consumption for the received command based on the amount of data to be processed (e.g., programmed, read, or erased).

At operation 315, the processing device determines whether the received command is a read command. For example, memory subsystem 110 determines whether the received command is a read command, a write command, or an erase command. If the processing device determines that the received command is a read command, the method 300 proceeds to operation 320. If the processing device determines that the received command is not a read command, the method 300 proceeds to operation 335.

At operation 320, the processing device determines whether the current power consumption added with the estimated power consumption of the received read command will exceed the power budget threshold. For example, read command management component 113 determines a current power consumption for memory subsystem 110 based on memory operations currently executing (or otherwise being managed in parallel). In some embodiments, read command management component 113 retrieves a current power consumption from a local memory (e.g., local memory 119 of FIG. 1). In some embodiments, power budget threshold is a percentage of or other offset from a peak power limit for the memory subsystem. For example, read command management component 113 determines power budget threshold 215 as 70% of peak power limit 225. In some embodiments, read command management component 113 determines the power budget threshold for the memory subsystem based on the memory device. For example, read command management component 113 determines power budget threshold 215 as 70% of peak power limit 225 in response to determining that a size of memory device 140 for memory subsystem 110 is larger than a threshold size.

Read command management component 113 adds the estimated power consumption for a reverse read command to the current power consumption for memory subsystem and determines whether the sum exceeds the power budget threshold. For example, read command management component 113 determines whether a received read operation will exceed power budget threshold 215 if the read operation is issued using a reverse read trim setting. If the processing device determines that the current power consumption added with the estimated power consumption will exceed the power budget threshold, the method 300 proceeds to operation 330. If the processing device determines that the current power consumption added with the estimated power consumption will not exceed the power budget threshold, the method 300 proceeds to operation 325.

At operation 325, the processing device issues a reverse read operation. For example, read command management component 113 selects a reverse read trim setting for the received read command and issues the reverse read operation to execute on the data identified in the received read command.

At operation 330, the processing device issues a forward read operation. For example, read command management component 113 selects a forward read trim setting for the received read command and issues the forward read operation to execute on the data identified in the received read command.

At operation 335, the processing device updates the power consumption for the issued operation. For example, read command management component 113 records the estimated power consumption and stores the estimated power consumption in local memory (e.g., local memory 119 of FIG. 1). In some embodiments, read command management component 113 adds the estimated power consumption to the current power consumption and stores the updated current power consumption in local memory (e.g., local memory 119). In some embodiments, operations that are fully completed are subtracted from the current power consumption. For example, after completing program operation 202, read command management component 113 removes program operation 202 from the current power consumption. In such embodiments, the updated power consumption is used for the next iteration of determining the power consumption.

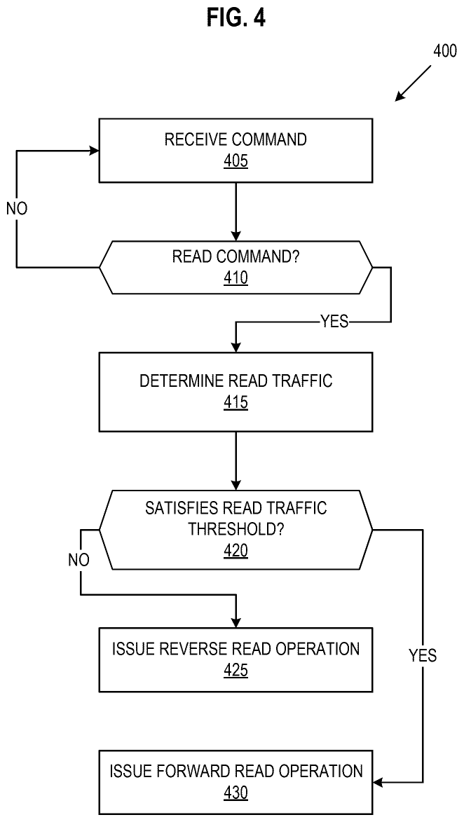

FIG. 4 is a flow diagram of an example method 400 to manage read command trim settings using command workloads, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the read command management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device receives a command. For example, memory subsystem 110 receives a command from host system 120 instructing memory subsystem 110 to perform a memory operation. In some embodiments, memory subsystem 110 receives one of a program command instructing memory subsystem 110 to write data to a memory device, a read command instructing memory subsystem 110 to read data from a memory device, and an erase command instructing memory subsystem 110 to erase data from a memory device.

At operation 410, the processing device determines whether the received command is a read command. For example, memory subsystem 110 determines whether the received command is a read command, a write command, or an erase command. If the processing device determines that the received command is a read command, the method 400 proceeds to operation 415. If the processing device determines that the received command is not a read command, the method 400 returns to operation 405.

At operation 415, the processing device determines read traffic. For example, read command management component 113 determines the number of read commands in a command queue of memory subsystem 110. In some embodiments, read command management component 113 determines the proportion of read command to other commands in a command queue.

At operation 420, the processing device determines whether the determined read traffic satisfies the read traffic threshold. For example, read command management component 113 determines whether the number of read commands in the command queue of memory subsystem 110 is greater than a threshold number of read commands. In some embodiments, read command management component 113 determines whether the ratio of read commands to other commands in the command queue is greater than a threshold ratio of read commands to other commands. In some embodiments, the read traffic threshold is stored in a local memory (e.g., local memory 119 of FIG. 1).

In some embodiments, read command management component 113 compares the current read traffic to previous read traffics and determines that the read traffic satisfies the read traffic threshold if the current read traffic is greater than the previous read traffic by a threshold amount. For example, read command management component 113 determines that the number of read commands in a command queue of memory subsystem 110 is increasing and determines a ratio of reverse read operation to forward read operations using the rate of increase of read commands in the command queue.

In some embodiments, read command management component 113 determines a ratio of forward read commands to reverse read commands based on one of the number of read commands in the command queue, the ratio of read commands in the command queue, and/or the change in the number and/or ratio of read commands. In such embodiments, read command management component 113 can determine whether to issue a forward or reverse read based on the determined ratio of forward read commands to reverse read commands. This allows read command management component 113 to anticipate the number of read commands exceeding the threshold in the future based on the current trend and change the ratio of forward read operations to reverse read operations before it becomes a problem.

If the processing device determines that the determined read traffic satisfies the read traffic threshold, the method 400 proceeds to operation 430. If the processing device determines that the determined read traffic does not satisfy the read traffic threshold, the method 400 proceeds to operation 425.

At operation 425, the processing device issues a reverse read operation. For example, read command management component 113 selects a reverse read trim setting for the received read command and issues the reverse read operation to execute on the data identified in the received read command.

At operation 430, the processing device issues a forward read operation. For example, read command management component 113 selects a forward read trim setting for the received read command and issues the forward read operation to execute on the data identified in the received read command.

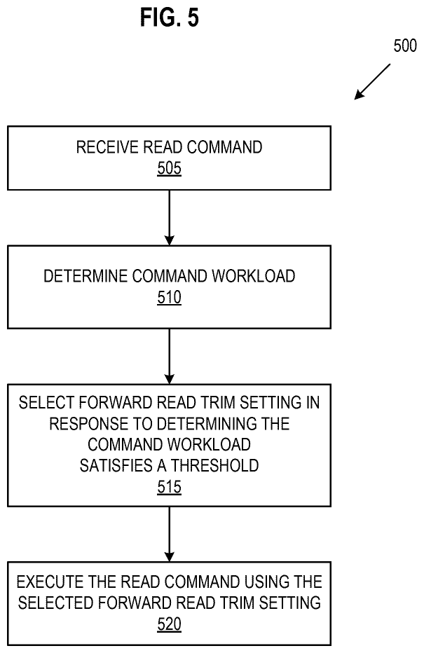

FIG. 5 is a flow diagram of an example method 500 to manage read command trim settings using command workloads, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the read command management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing device receives a read command. For example, memory subsystem 110 receives a read command from host system 120. In some embodiments, the read command includes a logical address indicating a memory portion of a memory device to read from and a data size indicating the amount of data to read from the indicated memory portion. In some embodiments, memory subsystem 110 translates the logical address into a physical address.

At operation 510, the processing device determines a command workload. For example, read command management component 113 determines a power consumption based on an estimated power consumption for the received read command and a current power consumption for memory subsystem 110. In some embodiments, read command management component 113 determines the number of read commands in a command queue of memory subsystem 110. In some embodiments, read command management component 113 determines a ratio of read commands to other commands in a command queue of memory subsystem 110. In some embodiments, read command management component 113 determines a change in the number of read commands in a command queue from a previous number of read commands in the command queue. In some embodiments, read command management component 113 determines a change in the ratio of read commands to other commands in a command queue from a previous ratio of read commands to other commands in the command queue.

At operation 515, the processing device selects a forward read trim setting in response to determining that the command workload satisfies a threshold. For example, read command management component 113 determines that the sum of the current power consumption for memory subsystem 110 and the estimated power consumption for the received read command is greater than a power budget threshold (e.g., power budget threshold 215 of FIG. 2) and selects a forward read trim setting for the received read command in response to that determination.

In some embodiments, read command management component 113 determines that the number of read commands in a command queue of memory subsystem 110 is greater than a threshold number of read commands and selects a forward read trim setting for the received read command in response to that determination. In some embodiments, read command management component 113 determines that the ratio of read commands to other commands in a command queue of memory subsystem 110 is greater than a threshold ratio of read commands to other commands and selects a forward read trim setting for the received read command in response to that determination.

In some embodiments, read command management component 113 determines that a change in the number of read commands in a command queue from a previous number of read commands in the command queue satisfies a threshold change and selects a forward read trim setting for the received read command in response to that determination. In some embodiments, read command management component 113 determines that a change in the ratio of read commands to other commands in a command queue from a previous ratio of read commands to other commands in the command queue satisfies a threshold change and selects a forward read trim setting for the received read command in response to that determination.

At operation 520, the processing device issues the read command using the selected forward read trim setting. For example, read command management component issues a forward read command to execute on a portion of memory portion indicated by the received read command. In some embodiments, read command management component 113 issues the forward read command to execute using the physical address determined by the logical address in the received read command.

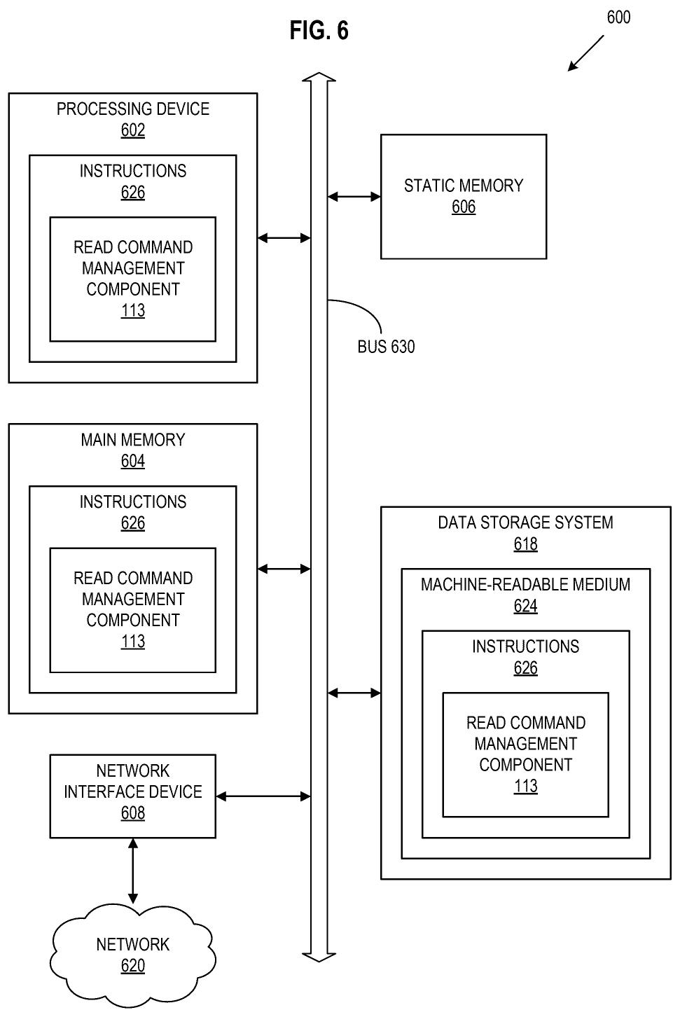

FIG. 6 illustrates an example machine of a computer system 600 within which a set of instructions for causing the machine to perform any one or more of the methodologies discussed herein can be executed. In some embodiments, the computer system 600 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the read command management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a smart device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a static memory 606 (e.g., flash memory, static random-access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626, constituting machine-readable storage media, can also reside, completely or at least partially, within the main memory 604 and/or within the processing device 602 during execution thereof by the computer system 600, the main memory 604 and the processing device 602. The machine-readable storage medium 624, data storage system 618, and/or main memory 604 can correspond to the memory subsystem 10 of FIG. 1.

In one embodiment, the instructions 626 include instructions to implement functionality corresponding to a read command management component (e.g., read command management component 113 of FIG. 1). While the machine-readable storage medium 624 is shown in an example embodiment to be a single medium, the term “machine-readable storage medium” should be taken to include a single medium or multiple media that store the one or more sets of instructions (e.g., instructions 626). The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 300, 400, and 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, by a memory subsystem, a read command;
determining a command workload for the memory subsystem;
selecting a forward read trim setting in response to determining the command workload of the memory subsystem satisfies a threshold; and
executing the read command using the selected forward read trim setting.

2. The method of claim 1, wherein determining the command workload comprises:
estimating a power consumption for the memory subsystem executing the read command, wherein the threshold is a power consumption threshold.

3. The method of claim 2, wherein the estimated power consumption is a sum of a current power consumption of the memory subsystem executing memory commands in a command queue and additional power consumption of the read command.

4. The method of claim 2, wherein the power consumption threshold is a percentage of a peak power threshold of the memory subsystem.

5. The method of claim 1, wherein determining the command workload comprises determining read traffic for the memory subsystem and wherein selecting the forward read trim setting is based on the read traffic satisfying a read traffic threshold.

6. The method of claim 5, wherein the read traffic comprises a number of read commands in a command queue of the memory subsystem and wherein the read traffic threshold comprises a threshold number of read commands.

7. The method of claim 1, the method further comprising:
receiving, by the memory subsystem, a second read command;
determining a second command workload for the memory subsystem;
selecting a reverse read trim setting in response to determining the second command workload of the memory subsystem does not satisfy a threshold; and
executing the second read command using the selected reverse read trim setting.

8. A non-transitory computer-readable storage medium comprising instructions that, when executed by a processing device, cause the processing device to:
receive, by a memory subsystem, a read command;
determine a command workload for the memory subsystem;
select a forward read trim setting in response to determining the command workload of the memory subsystem satisfies a threshold; and
execute the read command using the selected forward read trim setting.

9. The non-transitory computer-readable storage medium of claim 8, wherein determining the command workload comprises:
estimating a power consumption for the memory subsystem executing the read command, and wherein the threshold is a power consumption threshold.

10. The non-transitory computer-readable storage medium of claim 9, wherein the estimated power consumption is a sum of a current power consumption of the memory subsystem executing memory commands in a command queue and additional power consumption of the read command.

11. The non-transitory computer-readable storage medium of claim 9, wherein the power consumption threshold is a percentage of a peak power threshold of the memory subsystem.

12. The non-transitory computer-readable storage medium of claim 8, wherein determining the command workload comprises determining read traffic for the memory subsystem and wherein selecting the forward read trim setting is based on the read traffic satisfying a read traffic threshold.

13. The non-transitory computer-readable storage medium of claim 12, wherein the read traffic comprises a number of read commands in a command queue of the memory subsystem and wherein the read traffic threshold comprises a threshold number of read commands.

14. The non-transitory computer-readable storage medium of claim 8, wherein the processing device is further to:
receive, by the memory subsystem, a second read command;
determine a second command workload for the memory subsystem;
select a reverse read trim setting in response to determining the second command workload of the memory subsystem does not satisfy a threshold; and
execute the second read command using the selected reverse read trim setting.

15. A system comprising:
a plurality of memory devices; and
a processing device, operatively coupled with the plurality of memory devices, to:
receive, by a memory subsystem, a first read command;
determine a first command workload for the memory subsystem;
select a forward read trim setting in response to determining the first command workload of the memory subsystem satisfies a threshold;
execute the first read command using the selected forward read trim setting;
receive, by the memory subsystem, a second read command;
determine a second command workload for the memory subsystem;
select a reverse read trim setting in response to determining the second command workload of the memory subsystem does not satisfy the threshold; and
execute the second read command using the selected reverse read trim setting.

16. The system of claim 15, wherein:
determining the first command workload comprises estimating a first power consumption for the memory subsystem executing the first read command, wherein the threshold is a power consumption threshold; and
determining the second command workload comprises estimating a second power consumption for the memory subsystem executing the second read command.

17. The system of claim 16, wherein the first estimated power consumption is a sum of a power consumption of the memory subsystem executing memory commands in a command queue and additional power consumption of the first read command and wherein the second estimated power consumption is a sum of the power consumption of the memory subsystem executing memory commands in the command queue and additional power consumption of the second read command.

18. The system of claim 16, wherein the power consumption threshold is a percentage of a peak power threshold of the memory subsystem.

19. The system of claim 15, wherein determining the first and second command workloads each comprises determining read traffic for the memory subsystem, wherein selecting the forward read trim setting is based on the read traffic satisfying a read traffic threshold, and wherein selecting the reverse read trim setting is based on the read traffic not satisfying the read traffic threshold.

20. The system of claim 19, wherein the read traffic comprises a number of read commands in a command queue of the memory subsystem and wherein the read traffic threshold comprises a threshold number of read commands.
